(19) United States
(12) Patent Application Publication
(10) Pub. No.: US 2019/0060950 A1
(43) Pub. Date: Feb. 28, 2019

(54) SPINDLE PAINTING COVER

(71) Applicants: Frank Elardi, Jackson, NJ (US); John Anthony DePaola, Jackson, NJ (US)

(72) Inventors: Frank Elardi, Jackson, NJ (US); John Anthony DePaola, Jackson, NJ (US)

(21) Appl. No.: 16/116,367

(22) Filed: Aug. 29, 2018

Related U.S. Application Data
(60) Provisional application No. 62/551,295, filed on Aug. 29, 2017.

(51) Int. Cl. B05D 1/32; B44D 3/22

(52) U.S. Cl. CPC B05D 1/32; E04F 11/1814; B44D 3/22

(57) ABSTRACT

A bannister spindle painting cover having a head with a fixed dimension notch is formed therein, the notch including a first inside edge and a second inside edge with a third inside edge extending therebetween. The third inside edge is normal to the first and second inside edges, the first inside edge and said second inside edge being parallel to one another near the third inside edge. The cover may have a thickness of no greater than ¼″. The head may be planar. In use, the cover may be positioned around the square portion of a bannister spindle such that three sides of the spindle are in nominal contact with the notch to facilitate painting of the spindle while keeping adjacent stair treads paint free. The cover may be withdrawn and repositioned at least 90 degrees on the spindle as needed for painting multiple sides of the spindle.

### CROSS-REFERENCE TO RELATED APPLICATIONS

The present application claims the benefit of U.S. Patent Application Ser. No. 62/551,295 filed Aug. 29, 2017, entitled “SPINDLE PAINT SHIELD,” the disclosure of which is hereby incorporated by reference herein.

### BACKGROUND OF THE INVENTION

The present invention relates to painting of staircase handrail spindles. Specifically, the invention relates to devices used to save time and resources when painting spindles.

It is well known that staircases handrails contain a sloping top rail with vertical spindles extending down toward each stair tread. Historically, painting of these spindles has been a laborious and troubling endeavor due to the need to protect each stair tread from unintended paint application while painting the spindle and to protect the spindle while painting the underside of the sloping top rail.

### BRIEF SUMMARY OF THE INVENTION

It would therefore be advantageous to provide devices which aid a painter in painting spindles by covering or shielding the stair tread from paint application while painting each spindle and separately by covering or shielding each spindle during painting of the sloping top rail underside.

In accordance with one aspect of the invention, an upper spindle painting cover is provided, the upper spindle painting cover being planar with a first edge and second edge, and formed from resilient material such that the upper spindle painting cover has a natural condition where the first edge and the second edge are brought together such that the upper spindle painting cover forms a roll, the first edge and second edge being adapted to being resiliently spread apart to create a relatively flat surface in an open condition of the upper spindle painting cover.

In accordance with another aspect of the invention, a lower spindle painting cover is provided, the lower spindle painting cover including a bannister spindle painting cover having a head, a handle, and a midsection configured therebetween; a fixed dimension notch formed in the head, the notch including a first inside edge and a second inside edge with a third inside edge extending therebetween, the third inside edge being normal to the first and second inside edges, the first inside edge and the second inside edge being parallel to one another near the third inside edge.

The cover may have a thickness no greater than ¼″.

The head may be planar.

The head may be planar and the cover may further include structural ribs to stiffen the cover.

The head may be planar and the cover may further include structural ribs to stiffen the cover, wherein the structural ribs stiffen at least the handle.

The head may be planar and the cover may further include structural ribs to stiffen the cover, wherein the structural ribs stiffen at least the handle and the midsection.

The head may taper toward the handle at the midsection.

The cover may further include an aperture.

The third inside edge may have a nominal dimension of 1¼″.

In accordance with a third aspect of the invention, a kit is provided, the kit including at least one lower spindle painting cover and at least one upper spindle painting cover; the at least one lower spindle painting cover including a head, a handle, and a midsection configured therebetween with a fixed dimension notch formed in the head, the notch including a first inside edge and a second inside edge with a third inside edge extending therebetween, the third inside edge being normal to the first and second inside edges, the first inside edge and the second inside edge being parallel to one another near the third inside edge; the upper spindle painting cover being planar with a first edge and second edge, and formed from resilient material such that the upper spindle painting cover has a natural condition where the first edge and the second edge are brought together such that the upper spindle painting cover forms a roll, the first edge and second edge being adapted to being resiliently spread apart to create a relatively flat surface in an open condition of the upper spindle painting cover.

Each of the at least one lower spindle painting cover may have a thickness no greater than ¼″.

The head of each of the at least one lower spindle painting cover may be planar.

Each of the at least one lower spindle painting cover may further comprise structural ribs to stiffen the cover.

One of the at least one lower spindle painting covers may include a third inside edge having a nominal dimension of 1¼″.

In accordance with a further aspect of the invention, there is provided a method of painting a square portion of a bannister spindle with a painting cover, the painting cover including a head with a fixed dimension notch formed therein, the method including positioning the painting cover head around the square portion of the bannister spindle such that three sides of the bannister spindle are in nominal contact with the notch; painting at least one side of the square portion of the bannister spindle; removing the painting cover head and repositioning same around the square portion of the bannister spindle by at least 90 degrees; painting at least one remaining side of the square portion of the bannister spindle.

Painting at least one side may be painting three sides and painting at least one remaining side may be painting the only remaining side.

The method may further include resting the painting cover on the stair tread.

The method may further include resting the painting cover on the stair tread and compressing any carpeting found on the stair tread.

The square portion of the bannister spindle may nominally be 1¼″ and the notch may have a nominal dimension of 1¼″.

### BRIEF DESCRIPTION OF THE DRAWING FIGURES

The subject matter regarded as the invention is particularly pointed out and distinctly claimed in the concluding portion of the specification. The invention, however, both as to organization and method of operation, together with features, objects, and advantages thereof, will be or become apparent to one with skill in the art upon reference to the following detailed description when read with the accompanying drawings. It is intended that any additional organizations, methods of operation, features, objects or advantages ascertained by one skilled in the art be included within this description, be within the scope of the present invention, and be protected by the accompanying claims.

With respect to the drawings,

FIG. 1 depicts a top perspective view of a lower spindle painting cover in accordance with a first embodiment of the present invention;

FIG. 2 depicts a front view of the lower spindle painting cover of FIG. 1, the back view being identical;

FIG. 3 depicts the lower spindle painting cover of FIG. 1 in use on the square base of a conventional spindle;

FIGS. 4A and 4B depict a front views of an upper spindle painting cover in accordance with a second embodiment of the present invention, the upper spindle painting cover shown in FIG. 4A in its open condition and in FIG. 4B in its closed, or natural, condition; and,

FIG. 5 depicts both the upper spindle painting cover of FIGS. 4A and 4B and the lower spindle painting cover of FIGS. 1 and 2 in use on a conventional spindle.

### DETAILED DESCRIPTION

In the following are described the preferred embodiments of the SPINDLE PAINTING COVER of the present invention. In describing the embodiments illustrated in the drawings, specific terminology will be used for the sake of clarity. However, the invention is not intended to be limited to the specific terms so selected, and it is to be understood that each specific term includes all technical equivalents that operate in a similar manner to accomplish a similar purpose. Where like elements have been depicted in multiple embodiments, identical reference numerals have been used in the multiple embodiments for ease of understanding.

It is well known that conventional spindles of a bannister come in common sizes, one such spindle having a nominal 1¼″ square base.

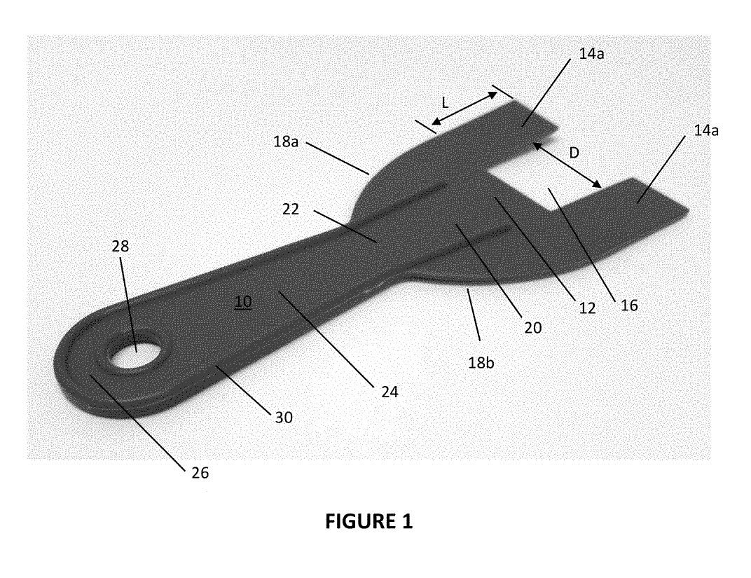

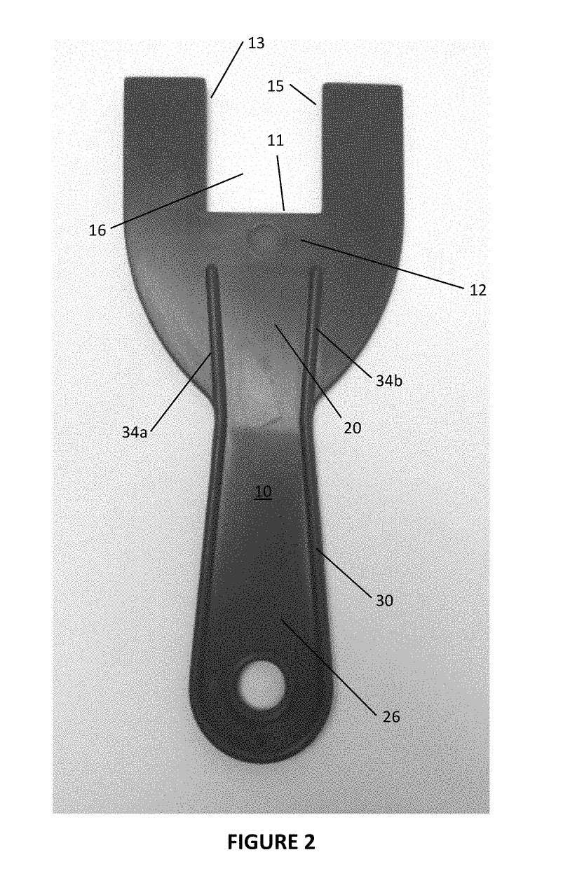

To accommodate the nominal 1¼″ square base of the conventional spindle, the lower spindle painting cover may have the configuration and dimensions shown in FIGS. 1 and 2. While other configurations and dimensions are, of course, possible, this configuration and dimension specification somewhat mirrors the common plastic spackle knife that so many painters are accustomed to using, and it is therefore comfortable to the hand.

In accordance with the embodiment of the invention shown in FIGS. 1 and 2, the lower spindle painting cover 10 includes a planar head portion 12 configured with a pair of extenders 14a, 14b. The extenders 14a, 14b form a fixed dimension notch 16 therebetween, with head inside edge 11 configured from the head 12 and spanning between extension inside edges 13 and 15 formed from portions of the extenders 14a, 14b, respectively. Extension inside edges 13 and 15 are parallel to each other at least nearest said head inside edge 11, and preferably remain so for a length at least equal to the length of head inside edge 11 whereupon they may spread wider apart.

Importantly, one possible dimension D for the notch 16 is 1¼″ to permit the notch to slide against the square base of a conventional spindle with a 1¼″ nominal square base. Other notch 16 dimensions are also possible and primarily would be those of conventional spindle square bases. As an example, such dimensions may be 1″, 1½″, 1¾″, or 2″. The length of extenders 14a, 14b may be shorter than dimension D, may be longer than dimension D, or preferably match dimension D. In the preferred embodiment the length L of extenders 14a, 14b is 1¼″ to match that of dimension D.

The outer edges 18a, 18b of the pair of extenders 14a, 14b taper inward at a midsection 20 of the lower spindle painting cover 10 to a meeting 22 where the midsection 20 meets the handle 24. The handle 24 then tapers outward slightly toward the distal end of the lower spindle painting cover 26, where there is provided a hang hole 28 through the handle.

Again, the overall shape of the lower spindle painting cover 10 is similar to a common plastic spackle knife and is comfortable in the hand. Moreover, the lower spindle painting cover 10 preferably has an overall thickness of approximately 1/32″ to ¼″ with 1/16″ being common, particularly for the head 12. In other embodiments, the handle 24 may be thicker than the head 12.

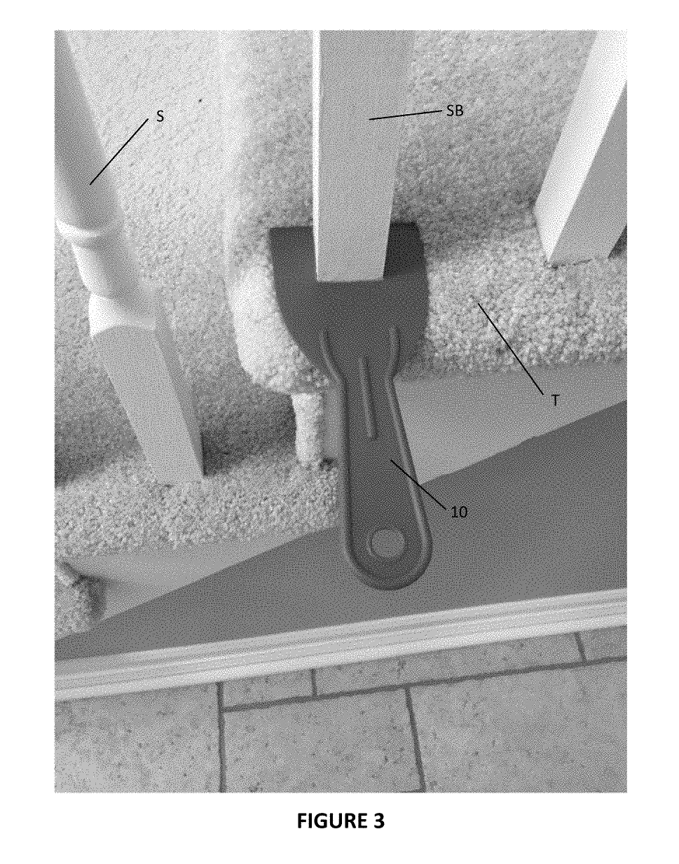

As shown in FIG. 3, a lower spindle painting cover may be provided for covering the stair tread surface T below the spindle S from paint during painting of the spindle. To do so, the lower spindle painting cover 10 is positioned around the square base SB of the spindle S such that the square base is relatively tight within the notch 16. In this position, at least one of the three sides of the spindle S adjacent to the lower spindle painting cover, i.e. those sides of the spindle adjacent to the pair of extenders 14a, 14b and the midsection 20, may be painted with the stair tread surface T below being shielded and remaining paint free. If the stair tread surface S is carpet, the lower spindle painting cover 10 may also be used to compress the carpeting such that the entire length of the spindle S may be painted. To paint the remaining side(s) of the spindle S, one would simply remove the lower spindle painting cover 10, rotate it either 90 or 180 degrees around the spindle S, and reposition it for painting of the remaining side(s). For efficiency one would typically paint three sides of the spindle S at once such that only one rotation step was necessary. However, any combination of painting/rotating would work right up to rotating four times.

The lower spindle painting cover may be manufactured from a variety of materials, including plastics. To stiffen the device, the lower spindle painting cover may include raised structural ribs, such as the continuous exterior edge rib 30 shown around the handle 24 and the interior rib 32 extending from the midsection 20 to the handle 24 shown clearly in FIGS. 2 and 3. It will also be appreciated that the continuous exterior edge rib 30 may extend into the midsection 20 as extension ribs 34a, 34b. Additional ribs, or ribs in other locations, may also be provided depending on the material used and configuration of the device. Preferably, the extension members 14a, 14b and head 12 are completely flat to permit the cover to lay flat against a stair tread surface S, particularly in the case of hardwood or other hard surfaces.

Although not shown, the thickness of the lower spindle cover 10 at the inside edges of the three sides of the lower spindle painting cover adapted to fit against a spindle S, i.e. the edges forming the notch 16, may be tapered down to a thickness less than that of the remaining portions of the lower spindle cover to enable painting as close to the stair tread surface S as possible.

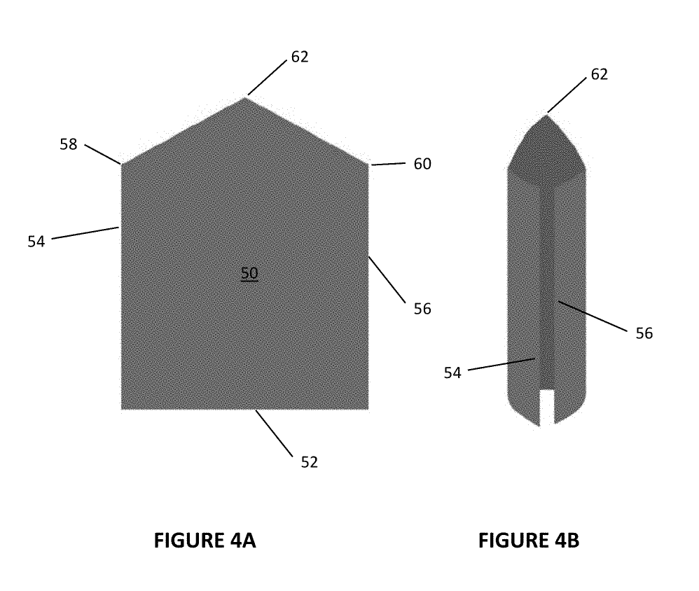

FIGS. 4A and 4B depict front views of an upper spindle painting cover 50 in accordance with a second embodiment of the present invention, the upper spindle painting cover being shown in its open condition in FIG. 4A and in its closed condition in FIG. 4B. It will be appreciated that the closed, or rolled, condition (i.e. forming a cylinder with a generally circular cross-section), is the natural condition of the upper spindle painting cover 50. Thus, when left to its natural condition, the upper spindle painting cover 50 will close as shown.

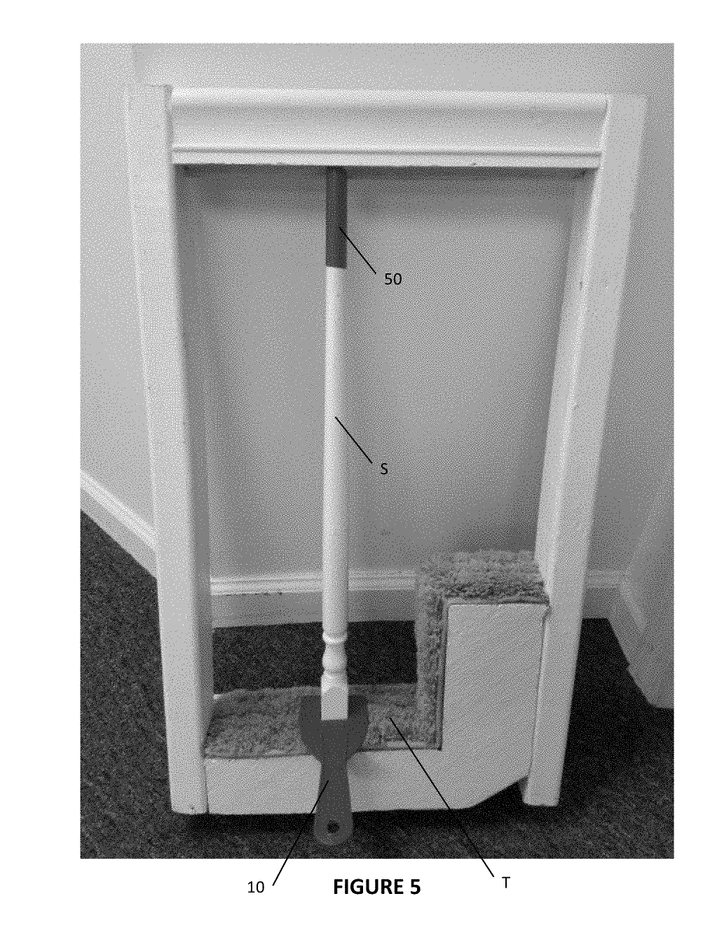

This natural tendency to close is what permits the upper spindle painting cover 50 to fit around the upper portion of a tapered or straight spindle S. The upper spindle painting cover 50 may be spread open and be positioned, as shown in FIG. 5, over a spindle S, where the upper spindle painting cover will resiliently rebound to its natural condition and wrap around the spindle. This enables a painter to paint the underside of the sloping top rail R of the bannister BA without paint also being applied to the spindle.

The upper spindle painting cover may be configured from a variety of materials, preferably those which are resilient such as thin plastic. As shown in the embodiment of FIGS. 4A and 4B, the upper spindle painting cover 50 is relatively rectangular with a peaked end. That is, the preferred embodiment of the upper spindle painting cover 50 is planar and includes a bottom edge 52 that extends to meet at right angles with first side edge 54 and second side edge 56, which extend parallel to each other. The two edges, first side edge 54 and second side edge 56, then angle obtusely toward each other at respective inflection points 58, 60, toward a peak 62 where they meet, forming a five-sided figure not unlike the configuration of home plate in baseball. Of course other configurations are possible.

The preferred upper spindle painting cover 50 has dimensions of 3″ from bottom edge 52 to peak 62 and 2¼″ from first side edge 54 to second side edge 56. The upper spindle painting cover also has a thickness of approximately 1 cm, or 0.4 in. Of course, other configurations and dimensions may′ be provided. For example, in other embodiments the spindle painting cover may have dimensions of 3″×2⅜″ with a thickness of approximately 0.4 in.

As used herein, the terms upper and lower have been provided with the various covers 10, 50 to recognize their typical locations on a spindle S. It is to be appreciated, however, that other spindle configurations might necessitate the use of the lower spindle painting cover 50 on the upper portion of the spindle S or the upper spindle painting cover 10 on the lower portion of the spindle, and such terms are used only for ease of explanation herein.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention.

1. A bannister spindle painting cover comprising:
a head, a handle, and a midsection configured therebetween;
a fixed dimension notch formed in said head, said notch including a first inside edge and a second inside edge with a third inside edge extending therebetween, said third inside edge being normal to said first and second inside edges, said first inside edge and said second inside edge being parallel to one another near said third inside edge.

2. The bannister spindle painting cover of claim 1, wherein said cover has a thickness no greater than ¼″.

3. The bannister spindle painting cover of claim 1, wherein said head is planar.

4. The bannister spindle painting cover of claim 3, further comprising structural ribs to stiffen the cover.

5. The bannister spindle painting cover of claim 4, wherein said structural ribs stiffen at least said handle.

6. The bannister spindle painting cover of claim 5, wherein said structural ribs stiffen at least said handle and said midsection.

7. The bannister spindle painting cover of claim 1, wherein said head tapers toward said handle at said midsection.

8. The bannister spindle painting cover of claim 1, further comprising an aperture.

9. The bannister spindle painting cover of claim 1, wherein said third inside edge has a nominal dimension of 1¼″.

10. A kit of painting tools comprising:
at least one lower spindle painting cover and at least one upper spindle painting cover;
said at least one lower spindle painting cover including a head, a handle, and a midsection configured therebetween with a fixed dimension notch formed in said head, said notch including a first inside edge and a second inside edge with a third inside edge extending therebetween, said third inside edge being normal to said first and second inside edges, said first inside edge and said second inside edge being parallel to one another near said third inside edge;
said upper spindle painting cover being planar with a first edge and second edge, and formed from resilient material such that said upper spindle painting cover has a natural condition where said first edge and said second edge are brought together such that said upper spindle painting cover forms a roll, the first edge and second edge being adapted to being resiliently spread apart to create a relatively flat surface in an open condition of said upper spindle painting cover.

11. The kit of claim 10, wherein each of said at least one lower spindle painting cover has a thickness no greater than ¼″.

12. The kit of claim 10, wherein said head of each of said at least one lower spindle painting cover is planar.

13. The kit of claim 10, wherein each of said at least one lower spindle painting cover further comprises structural ribs to stiffen the cover.

14. The kit of claim 10, wherein one of said at least one lower spindle painting covers includes a third inside edge having a nominal dimension of 1¼″.

15. A method of painting a square portion of a bannister spindle with a painting cover, the painting cover including a head with a fixed dimension notch formed therein, the method comprising:
positioning the painting cover head around the square portion of the bannister spindle such that three sides of the bannister spindle are in nominal contact with the notch;
painting at least one side of the square portion of the bannister spindle;
removing the painting cover head and repositioning same around the square portion of the bannister spindle by at least 90 degrees;
painting at least one remaining side of the square portion of the bannister spindle.

16. The method of claim 15, wherein painting at least one side is painting three sides and painting at least one remaining side is painting the only remaining side.

17. The method of claim 15, further comprising resting the painting cover on the stair tread.

18. The method of claim 17, further comprising compressing any carpeting found on the stair tread.

19. The method of claim 15, wherein said square portion of the bannister spindle is nominally 1¼″ and said notch has a dimension of nominally 1¼″.
